(19) United States
(12) Patent Application Publication
(10) Pub. No.: US 2026/0061358 A1
(43) Pub. Date: Mar. 5, 2026

(54) METHANE PURIFICATION APPARATUS

(71) Applicant: ISUZU MOTORS LIMITED, Yokohama-shi (JP)

(72) Inventors: Hisashi OZAWA, Fujisawa-shi (JP); Ryusuke FUJINO, Fujisawa-shi (JP); Teppei OHORI, Fujisawa-shi (JP)

(21) Appl. No.: 19/300,707

(22) Filed: Aug. 15, 2025

(30) Foreign Application Priority Data
Sep. 4, 2024 (JP) 2024-152458

(51) Int. Cl. B01D 51/10; B01D 53/26; B01D 53/86

(52) U.S. Cl. CPC B01D 51/10; B01D 53/265; B01D 53/8668; B01D 53/8696; B01D 2251/104; B01D 2255/20738; B01D 2255/20746; B01D 2255/50; B01D 2257/7025; B01D 2257/80; B01D 2258/06

(57) ABSTRACT

A methane purification apparatus includes: a gas cooling unit that cools a first gas by exchanging heat between the first gas and a refrigerant; an ozone supply unit that supplies ozone to the first gas cooled by the gas cooling unit; a gas heating unit that heats a second gas by exchanging heat between (i) the second gas containing the first gas and ozone and (ii) the refrigerant; a circulation path in which the refrigerant circulates between the gas cooling unit and the gas heating unit; and a refrigerant cooling unit that lowers the temperature of the refrigerant; a refrigerant heating unit that raises the temperature of the refrigerant; and a catalyst that decomposes methane contained in the second gas.

### CROSS-REFERENCE TO RELATED APPLICATIONS

The present application claims priority to Japanese Patent Application number 2024-152458, filed on Sep. 4, 2024, contents of which are incorporated herein by reference in its entirety.

### BACKGROUND OF THE INVENTION

The present invention relates to a methane purification apparatus. Conventional pollutant treatment methods remove methane contained in a gas containing methane and ozone and having a temperature within a predetermined range by bringing the gas into contact with a catalyst and oxidizing the methane with ozone (for example, Japanese Unexamined Patent Application Publication No. 2021-505376).

As the temperature of methane increases, it becomes more likely to react on a catalyst, whereas as the temperature of ozone increases, it becomes more likely to decompose itself. As a result, it becomes difficult to oxidize methane. Therefore, a measure of raising the temperature to a temperature at which ozone is less likely to decompose and allowing methane and ozone to react can be considered. However, in this case, water condensed from water vapor contained in the gas adheres to the catalyst, making it difficult for methane and ozone to react on the catalyst.

### BRIEF SUMMARY OF THE INVENTION

The present disclosure has been made in view of these points, and it aims to allow methane and ozone to react while suppressing the adhesion of water to a catalyst.

A methane purification apparatus according to an aspect of the present disclosure includes: a flow path through which a first gas containing methane flows; a gas cooling unit that cools the first gas by exchanging heat between the first gas flowing through the flow path and a refrigerant; an ozone supply unit that supplies ozone to the first gas cooled by the gas cooling unit; a gas heating unit that is provided downstream of the gas cooling unit in the flow path and heats a second gas by exchanging heat between (i) the second gas containing the first gas flowing through the flow path and the ozone supplied by the ozone supply unit and (ii) the refrigerant; a circulation path that connects the gas cooling unit and the gas heating unit and in which the refrigerant circulates between the gas cooling unit and the gas heating unit; a refrigerant cooling unit that is provided upstream of the gas cooling unit and downstream of the gas heating unit in a circulation direction of the circulation path and lowers a temperature of the refrigerant; a refrigerant heating unit that is provided downstream of the gas cooling unit and upstream of the gas heating unit in the circulation direction of the circulation path and raises the temperature of the refrigerant; and a catalyst that is provided downstream of the gas heating unit in the flow path and decomposes methane contained in the second gas.

### BRIEF DESCRIPTION OF THE DRAWINGS

FIG. 1 is a diagram showing an outline of a methane purification apparatus 1 according to the present embodiment.

FIG. 2 is a diagram showing an example of a methane decomposition rate map.

FIG. 3 is a diagram showing an example of a processing sequence in the methane purification apparatus 1.

### DETAILED DESCRIPTION OF THE INVENTION

Hereinafter, the invention will be described through embodiments of the invention. The below embodiments, however, are not intended to limit the invention according to the claims, and all combinations of features described in the embodiments are not necessarily essential to the solutions of the invention.

### <Overview of a Methane Purification Apparatus 1>

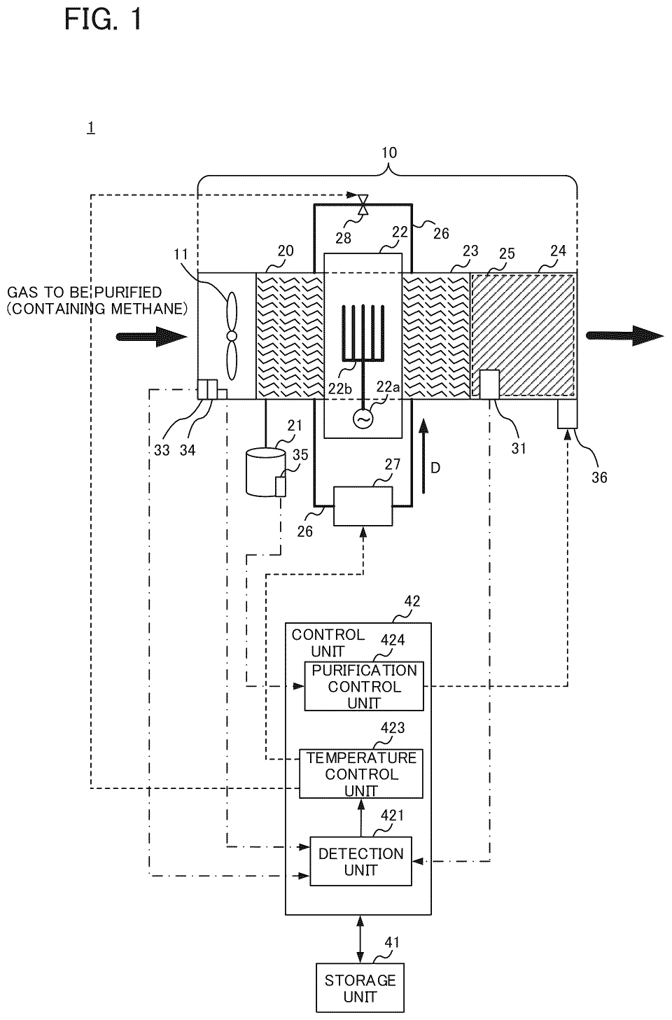

FIG. 1 is a diagram showing an overview of a methane purification apparatus 1 according to the present embodiment. The methane purification apparatus 1 illustrated in FIG. 1 includes a flow path 10, an intake unit 11, a gas cooling unit 20, a water tank 21, an ozone supply unit 22, a gas heating unit 23, a methane decomposition unit 24, a circulation path 26, a refrigerant heating unit 27, a refrigerant cooling unit 28, a temperature sensor 31, a temperature sensor 33, a humidity sensor 34, a water level sensor 35, a warning unit 36, a storage unit 41, and a control unit 42. The methane purification apparatus 1 is an apparatus that decomposes methane contained in air to generate water and carbon dioxide.

The flow path 10 is a flow path through which air containing methane (hereinafter referred to as “first gas”) flows. The intake unit 11 is, for example, an intake fan, and draws the first gas into the flow path 10 from outside the flow path 10.

The gas cooling unit 20 is provided downstream of the intake unit 11 and upstream of the ozone supply unit 22 in the flow path 10, and cools the first gas by exchanging heat between (i) the first gas flowing through the flow path 10 and (ii) refrigerant. The gas cooling unit 20 includes, for example, stacked fins and heat transfer tubes that penetrate the fins, and cools the first gas by vaporizing refrigerant, which is low-temperature, low-pressure liquid flowing through the heat transfer tubes, by exchanging heat between (i) the first gas flowing between the stacked fins and (ii) the refrigerant. Then, by cooling the first gas, the gas cooling unit 20 generates water from water vapor contained in the first gas and removes the water vapor. One end portion of the heat transfer tube included in the gas cooling unit 20 is connected to the circulation path 26. The water tank 21 is a tank for storing water generated by cooling the first gas in the gas cooling unit 20.

The ozone supply unit 22 is provided downstream of the gas cooling unit 20 and upstream of the gas heating unit 23 in the flow path 10, and supplies ozone to the first gas cooled by the gas cooling unit 20. The ozone supply unit 22 includes, for example, an AC power source 22a and electrodes 22b covered with a dielectric such as glass, and supplies ozone by performing a process of generating ozone by applying an AC voltage to the electrodes 22b by the AC power source 22a (so-called silent discharge method). The ozone supply unit 22 may generate ozone by performing a process in which discharge occurs on the surface of dielectric that covers the electrodes (so-called, creeping discharge method), a process in which water is electrolyzed (so-called, electrolysis method), or a process in which ultraviolet light is irradiated onto the first gas (so-called, ultraviolet lamp method). By supplying the generated ozone to the first gas, the ozone supply unit 22 generates a second gas containing the first gas and ozone.

The gas heating unit 23 is provided downstream of the gas cooling unit 20 in the flow path 10, and heats the second gas by exchanging heat between (i) the second gas containing the first gas flowing through the flow path 10 and ozone supplied by the ozone supply unit 22 and (ii) refrigerant. In FIG. 1, the gas heating unit 23 is provided further downstream of the ozone supply unit 22 provided downstream of the gas cooling unit 20 and upstream of the methane decomposition unit 24 in the flow path 10. The gas heating unit 23 includes, for example, stacked fins and heat transfer tubes penetrating the fins, and heats the second gas by condensing the refrigerant into a liquid by exchanging heat between (i) the second gas flowing among the stacked fins and (ii) the refrigerant, which is high-temperature, high-pressure vapor flowing through the heat transfer tubes. One end portion of the heat transfer tube included in the gas heating unit 23 is connected to the circulation path 26.

The methane decomposition unit 24 is provided downstream of the gas heating unit 23 in the flow path 10, and houses a catalyst 25. The methane decomposition unit 24 generates water and carbon dioxide by decomposing methane, for example, by causing ozone and methane contained in the second gas heated by the gas heating unit 23 to react on the catalyst 25.

The catalyst 25 is provided downstream of the gas heating unit 23 in the flow path 10, and decomposes methane contained in the second gas. The catalyst 25 includes a carrier having a predetermined structure and a coating layer supported on the surface of the carrier. The predetermined structure is, for example, a honeycomb structure, a corrugated structure, a mesh structure, or a porous structure. The material of the carrier is, for example, cordierite, silicon carbide, aluminum titanate, stainless steel, iron-chromium aluminum alloy, glass wool, glass fiber, or titanium. The coating layer includes, for example, zeolite, iron ion-exchanged zeolite, or cobalt ion-exchanged zeolite. The region of the surface of the carrier may include a region that does not support the coating layer.

The circulation path 26 connects the gas cooling unit 20 and the gas heating unit 23, and is a flow path for circulating the refrigerant between the gas cooling unit 20 and the gas heating unit 23. The refrigerant heating unit 27 is provided downstream of the gas cooling unit 20 and upstream of the gas heating unit 23 in a circulation direction D of the circulation path 26, and raises the temperature of the refrigerant. The refrigerant heating unit 27 includes, for example, a compressor, and compresses the refrigerant, which is low-temperature, low-pressure vapor flowing from the gas cooling unit 20 into the circulation path 26, thereby converting the refrigerant into high-temperature, high-pressure vapor, and outputs the high-temperature, high-pressure vapor to the gas heating unit 23 via the circulation path 26.

The refrigerant cooling unit 28 is provided upstream of the gas cooling unit 20 and downstream of the gas heating unit 23 in the circulation direction D of the circulation path 26, and lowers the temperature of the refrigerant. The refrigerant cooling unit 28 includes, for example, an expansion valve, reduces the pressure of the refrigerant that is a high-temperature, high-pressure liquid flowing from the gas heating unit 23 into the circulation path 26, converts the refrigerant into a low-temperature, low-pressure liquid, and outputs the liquid to the gas cooling unit 20 via the circulation path 26.

The temperature sensor 31 is a sensor for detecting the temperature of the second gas flowing through the methane decomposition unit 24, which is provided on the inner wall surface of the methane decomposition unit 24, and is, for example, a thermistor or a thermocouple. The temperature sensor 33 is a sensor for detecting the temperature of the first gas provided upstream of the intake unit 11 in the flow path 10, and is, for example, a thermistor or a thermocouple. The humidity sensor 34 is a sensor for detecting the humidity of the first gas provided upstream of the intake unit 11 in the flow path 10, and includes, for example, a moisture sensitive agent sandwiched between electrodes. The temperature sensor 33 and the humidity sensor 34 may be provided downstream of the intake unit 11 and upstream of the gas cooling unit 20 in the flow path 10.

The water level sensor 35 is a sensor for detecting the distance (height) from the bottom surface of the water tank 21 to the water surface of the water stored in the water tank 21. As one example, the water level sensor 35 detects the distance from the bottom surface to the water surface on the basis of the position at which a float suspended in the water tank 21 floats on the water surface of the water stored in the water tank 21. The warning unit 36 includes, for example, a warning lamp, and indicates whether the water tank 21 is full. For example, the warning unit 36 turns on the warning lamp when the water tank 21 is full, and turns off the warning lamp when the water tank 21 is not full. For example, the warning unit 36 acquires instruction information indicating an instruction to turn on or off the warning lamp from the control unit 42, and executes an instruction (turn on or off) included in the instruction information.

The storage unit 41 includes, for example, a storage medium such as a ROM (Read Only Memory), a RAM (Random Access Memory), a hard disk drive (HDD), or a solid state drive (SSD). The storage unit 41 stores programs executed by the control unit 42 and various types of information for decomposing methane contained in the second gas.

The control unit 42 includes a processor such as a CPU (Central Processing Unit). The control unit 42 causes the refrigerant cooling unit 28 to cool the refrigerant, thereby allowing the gas cooling unit 20 to exchange heat between the first gas and the refrigerant so as to cool the first gas and remove water vapor contained in the first gas. The control unit 42 causes the refrigerant heating unit 27 to heat the refrigerant, thereby allowing the gas heating unit 23 to exchange heat between the second gas and the refrigerant so as to heat the second gas and causing methane and ozone contained in the second gas to react on the catalyst 25. The control unit 42 may be configured by a single processor, or may be configured by a plurality of processors or a combination of one or more processors and an electronic circuit.

Since the control unit 42 operates in this manner, by causing the first gas from which water vapor has been removed to react with the second gas generated by supplying ozone on the catalyst 25, the methane purification apparatus 1 can decompose methane contained in the second gas. As a result, since the amount of water vapor decreases in the first gas, the control unit 42 can suppress the reduction in reactivity between methane and ozone on the catalyst 25 by preventing water, which is condensed from the water vapor contained in the second gas, from adhering to the catalyst 25 and blocking a region (so-called reaction site) where methane and ozone come into contact on the catalyst 25 and react. Hereinafter, the configuration and operation of the control unit 42 will be described in detail.

### <Configuration of the Control Unit 42.>

As illustrated in FIG. 1, the control unit 42 includes a detection unit 421, a temperature control unit 423, and a purification control unit 424. The control unit 42 functions as the detection unit 421, the temperature control unit 423, and the purification control unit 424 by executing programs stored in the storage unit 41.

The detection unit 421 detects the temperature of the catalyst 25. The detection unit 421 acquires, for example, the temperature of the second gas flowing through the methane decomposition unit 24, which is detected by the temperature sensor 31, as the temperature of the catalyst 25. The detection unit 421 detects the temperature and the humidity of the first gas at an inlet of the flow path 10. For example, the detection unit 421 acquires the temperature detected by the temperature sensor 33 as the temperature of the first gas at the inlet of the flow path 10, and acquires the humidity detected by the humidity sensor 34 as the humidity of the first gas at the inlet of the flow path 10.

The temperature control unit 423 causes the refrigerant cooling unit 28 to cool the refrigerant, thereby allowing the gas cooling unit 20 to exchange heat between the refrigerant cooled by the refrigerant cooling unit 28 and the first gas, so as to cool the first gas. For example, the temperature control unit 423 identifies a target cooling temperature for removing water vapor contained in the first gas on the basis of the temperature and humidity at the inlet of the flow path 10, and causes the refrigerant cooling unit 28 to cool the refrigerant so that the temperature of the first gas reaches the target cooling temperature.

For example, by referencing a temperature map indicating the target cooling temperature corresponding to temperature and humidity, which is stored in the storage unit 41, the temperature control unit 423 identifies a target cooling temperature corresponding to the temperature detected by the temperature sensor 33 and the humidity detected by the humidity sensor 34, which are acquired by the detection unit 421. The temperature map indicates a target cooling temperature that is lower than the temperature at the inlet of the flow path 10 as the humidity at the inlet of the flow path 10 increases, for example. Then, for example, the temperature control unit 423 adjusts a valve opening degree of the expansion valve included in the refrigerant cooling unit 28 so as to reduce the temperature difference between the temperature of the first gas detected by the temperature sensor 33 and the target cooling temperature corresponding to the humidity and the temperature of the first gas detected by the humidity sensor 34. For example, the temperature control unit 423 increases the valve opening degree as the temperature difference increases.

By operating as described above, the temperature control unit 423 can cause the refrigerant cooling unit 28 to cool the refrigerant flowing into the gas cooling unit 20. By exchanging heat between the refrigerant cooled by the refrigerant cooling unit 28 and the first gas, the gas cooling unit 20 can generate water condensed from water vapor contained in the first gas. As a result, the temperature control unit 423 can reduce the amount of water vapor contained in the first gas.

The temperature control unit 423 causes the refrigerant heating unit 27 to heat the refrigerant, thereby allowing the gas heating unit 23 to exchange heat between the refrigerant heated by the refrigerant heating unit 27 and the second gas, so as to heat the second gas. For example, the temperature control unit 423 causes the refrigerant heating unit 27 to heat the refrigerant so that the temperature of the second gas detected by the detection unit 421 falls within a target temperature range, which indicates temperatures at which the amount of methane decomposed by the catalyst 25 of the amount of methane contained in the second gas is equal to or greater than a predetermined ratio. The target temperature range is within a temperature range in which ozone contained in the second gas is less likely to thermally decompose, and is, for example, 50° C. or more and less than 150° C.

The temperature control unit 423 includes, for example, a feedback controller whose target heating temperature (target value) is a temperature within the target temperature range, and adjusts the rotation speed of a motor of the compressor included in the refrigerant heating unit 27 so as to reduce the temperature difference between the temperature of the second gas and the target heating temperature. For example, when the temperature of the second gas is lower than the target heating temperature, the temperature control unit 423 increases the rotation speed of the motor as the temperature difference becomes larger, and when the temperature of the second gas is equal to or higher than the target heating temperature, the temperature control unit 423 decreases the rotation speed of the motor as the temperature difference becomes larger.

By operating as described above, the temperature control unit 423 can cause the refrigerant heating unit 27 to heat the refrigerant flowing into the gas heating unit 23. The gas heating unit 23 can then heat the second gas to a temperature within the target temperature range by exchanging heat between the refrigerant heated by the refrigerant heating unit 27 and the second gas. As a result, the temperature control unit 423 can cause methane contained in the second gas to react with ozone on the catalyst 25 at a temperature at which methane readily decomposes. Furthermore, since the temperature control unit 423 can cause the gas heating unit 23 to heat the second gas, which contains the first gas from which water vapor has been removed, and cause the second gas to react on the catalyst 25, it is possible to suppress the reaction sites from being blocked by water formed by condensation of the water vapor contained in the second gas.

It is preferable that the temperature of the refrigerant cooled by the refrigerant cooling unit 28 for removing water vapor from the first gas be higher than the freezing point of the refrigerant and close to the freezing point (e.g., higher than 0° C. and close to 0° C. when the refrigerant is water). However, as the temperature of the cooled refrigerant becomes lower, it becomes more difficult for the refrigerant heating unit 27 to raise the temperature of the refrigerant to the target heating temperature.

Therefore, the temperature control unit 423 may lower the target heating temperature of the refrigerant heated by the refrigerant heating unit 27, as the target cooling temperature of the refrigerant cooled by the refrigerant cooling unit 28 becomes lower. For example, the larger the valve opening degree of the expansion valve included in the refrigerant cooling unit 28 is, the lower the temperature control unit 423 sets a target heating temperature within the target temperature range, and the more the temperature control unit 423 reduces the rotation speed of the motor of the compressor included in the refrigerant heating unit 27. By operating in this manner, the temperature control unit 423 can lower the temperature of the first gas to a temperature at which water vapor contained in the first gas can be readily removed, and raise the temperature of the second gas to a temperature at which methane and ozone can readily react.

The methane decomposition rate (the ratio of the amount of methane decomposed by the catalyst 25 to the amount of methane contained in the second gas that has flowed into the methane decomposition unit 24) corresponding to the temperature of the second gas varies depending on the type of the coating layer of the catalyst 25. Therefore, the temperature control unit 423 may identify the target temperature range by referencing a methane decomposition rate map stored in the storage unit 41. The methane decomposition rate map is a map indicating the methane decomposition rate corresponding to the temperature of the catalyst 25 for each type of the coating layer of the catalyst 25.

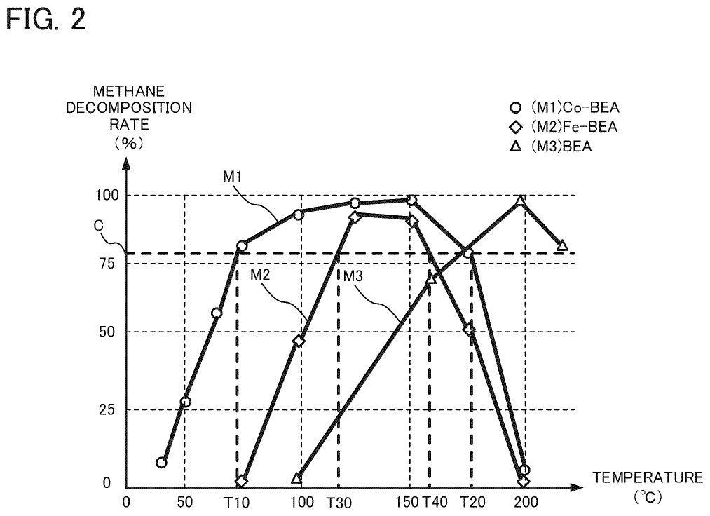

FIG. 2 is a diagram showing an example of the methane decomposition rate map. The horizontal axis of FIG. 2 indicates the temperature of the catalyst 25 (the temperature of the second gas), and the vertical axis of FIG. 2 indicates the methane decomposition rate. In FIG. 2, a catalyst M1, a catalyst M2, and a catalyst M3 are shown as the types of the catalyst 25. The coating layer of the catalyst M1 is a cobalt ion-exchanged zeolite (Co-BEA) in which cobalt is supported on a β-type framework zeolite. The coating layer of the catalyst M2 is an iron ion-exchanged zeolite (Fe-BEA) in which iron is supported on a β-type framework zeolite. The coating layer of the catalyst M3 is a β-type framework zeolite (BEA).

For example, when the coating layer of the catalyst 25 is cobalt ion-exchanged zeolite, the temperature control unit 423 identifies, by referencing the methane decomposition rate map shown in FIG. 2, the target temperature range “a temperature of T10° C. or more and less than T20”, in which the methane decomposition rate of the catalyst M1 is equal to or higher than a decomposition rate C. For example, when the coating layer of the catalyst 25 is iron ion-exchanged zeolite, the temperature control unit 423 identifies, by referencing the methane decomposition rate map shown in FIG. 2, the target temperature range “a temperature of T30° C. or more and less than T40° C.”, in which the methane decomposition rate of the catalyst M2 is equal to or higher than the decomposition rate C. By operating in this manner, the temperature control unit 423 can identify an optimum target temperature range according to the type of the coating layer of the catalyst 25.

The temperature control unit 423 acquires, from the methane decomposition unit 24 or the storage unit 41, catalyst identification information (hereinafter, referred to as “catalyst ID”) for identifying the catalyst 25 corresponding to the catalyst 25 housed in the methane decomposition unit 24, and identifies the type of the coating layer of the catalyst 25 corresponding to the catalyst ID. For example, the temperature control unit 423 identifies the type of the coating layer of the catalyst 25 corresponding to the acquired catalyst ID by referencing a coating layer table stored in the storage unit 41 that indicates the type of the coating layer associated with each catalyst ID.

Then, the temperature control unit 423 identifies the target temperature range in the identified type of the coating layer of the catalyst 25, for example, by referencing the methane decomposition rate map stored in the storage unit 41. By operating as described above, the temperature control unit 423 can identify the target temperature range according to the type of the catalyst 25 housed in the methane decomposition unit 24. Furthermore, even when a user of the methane purification apparatus 1 replaces the catalyst 25 with another catalyst 25 different from the type of the catalyst 25 before the replacement, the temperature control unit 423 can identify a target temperature range optimal for the other catalyst 25 after the replacement.

The purification control unit 424 turns on or off the warning lamp of the warning unit 36 on the basis of the water level (the distance from the bottom surface to the water surface) of the water tank 21 detected by the water level sensor 35. For example, when the amount of water stored in the water tank 21 is equal to or greater than a predetermined amount, the purification control unit 424 stops the gas cooling unit 20, the gas heating unit 23, the refrigerant cooling unit 28, and the refrigerant heating unit 27, and causes the warning unit 36 to turn on the warning lamp. The predetermined amount is, for example, an amount equivalent to a predetermined ratio (for example, 80%) of the amount of water that can be stored in the water tank 21, and is stored in the storage unit 41. When the amount of water stored in the water tank 21 is equal to or greater than the predetermined amount, the purification control unit 424 may also stop the intake unit 11 and the ozone supply unit 22.

For example, when the amount of water stored in the water tank 21 is less than the predetermined amount, the purification control unit 424 causes the warning unit 36 to turn off the warning lamp. By operating as described above, the purification control unit 424 informs the user of the methane purification apparatus 1 that the amount of water stored in the water tank 21 has reached or exceeds the predetermined amount (i.e., the tank is full), and can prevent the stored water from overflowing outside the water tank 21.

### <Process Sequence in Methane Purification Apparatus 1>

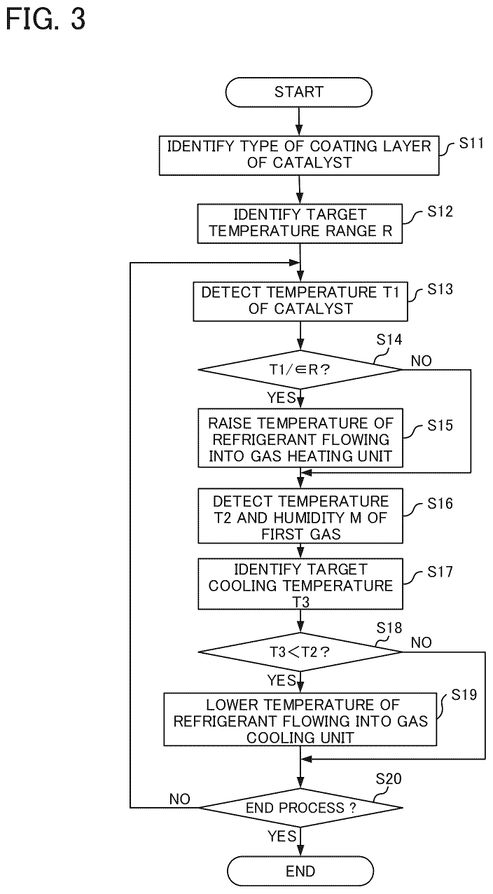

FIG. 3 is a diagram showing an example of a processing sequence in the methane purification apparatus 1. The processing sequence illustrated in FIG. 3 is a processing sequence in which the temperature control unit 423 controls the refrigerant heating unit 27 and the refrigerant cooling unit 28 so that the temperature of the catalyst 25 (that is, the temperature of the second gas) reaches the temperature within a target temperature range R and the temperature of the first gas reaches a target cooling temperature T3.

By referencing a coating layer table stored in the storage unit 41, the temperature control unit 423 identifies the type of the coating layer of the catalyst 25 corresponding to a catalyst ID acquired from the methane decomposition unit 24 (Step S11). The temperature control unit 423 identifies a target temperature range R, which indicates temperatures at which the methane decomposition rate becomes equal to or higher than a decomposition rate C in the identified type of the coating layer of the catalyst 25, by referencing a methane purification rate map stored in the storage unit 41 (Step S12).

The detection unit 421 detects a temperature T1 of the catalyst 25 (i.e., the temperature T1 of the second gas) by acquiring the temperature from the temperature sensor 31 (step S13). If the temperature T1 is not within the target temperature range R (YES in step S14), the temperature control unit 423 causes the refrigerant heating unit 27 to heat the refrigerant, thereby raising the temperature of the refrigerant flowing into the gas heating unit 23 (step S15). If the temperature T1 is within the target temperature range R (NO in step S14), the temperature control unit 423 does not execute a process of causing the refrigerant heating unit 27 to heat the refrigerant.

The detection unit 421 detects a temperature T2 of the first gas by acquiring the temperature from the temperature sensor 33, and detects a humidity M of the first gas by acquiring the humidity from the humidity sensor 34 (step S16). The temperature control unit 423 identifies a target cooling temperature T3 corresponding to the temperature T2 and the humidity M by referencing a temperature map stored in the storage unit 41 (step S17).

If the temperature T2 is higher than the target cooling temperature T3 (YES in step S18), the temperature control unit 423 causes the refrigerant cooling unit 28 to cool the refrigerant, thereby lowering the temperature of the refrigerant flowing into the gas cooling unit 20 (step S19). If the temperature T2 is equal to or lower than the target cooling temperature T3 (NO in step S18), the temperature control unit 423 does not execute the process of causing the refrigerant cooling unit 28 to cool the refrigerant.

If the methane purification apparatus 1 does not receive an operation to end the process (NO in step S20), the methane purification apparatus 1 repeats the process from step S13 to step S19. If the methane purification apparatus 1 receives the operation to end the process (YES in Step S20), the methane purification apparatus 1 ends the process.

### First Modification

In the above description, the operation in which the methane purification apparatus 1 decomposes methane contained in air is exemplified, but the operation is not limited thereto. The methane purification apparatus 1 may decompose methane contained in exhaust gas discharged from equipment or a vehicle installed in a plant. As one example, the methane purification apparatus 1 may be provided in an exhaust passage downstream of an engine included in the vehicle, and may decompose methane contained in exhaust gas of the engine.

### Second Modification

In the above description, the configuration in which the water tank 21 stores water generated by cooling the first gas with the gas cooling unit 20 is exemplified, but the configuration is not limited thereto. The methane purification apparatus 1 may have a drainage hose (not shown) instead of the water tank 21 to drain the generated water from the drainage hose. With such a configuration, when the methane purification apparatus 1 is installed in a place where the drainage facility is provided, water can be drained using the drainage facility. Furthermore, the methane purification apparatus 1 does not need to include the water tank 21, the water level sensor 35, the warning unit 36, and the purification control unit 424.

### <Effects of the Methane Purification Apparatus 1>

As described above, the methane purification apparatus 1 includes: the flow path 10 through which the first gas containing methane flows; the gas cooling unit 20 that cools the first gas by exchanging heat between the first gas flowing through the flow path 10 and the refrigerant; the ozone supply unit 22 that supplies ozone to the first gas cooled by the gas cooling unit 20; the gas heating unit 23 that is provided downstream of the gas cooling unit 20 in the flow path 10 and heats the second gas by exchanging heat between (i) the second gas containing the first gas flowing through the flow path 10 and ozone supplied by the ozone supply unit 22 and (ii) the refrigerant; a circulation path 26 that connects the gas cooling unit 20 and the gas heating unit 23 and in which the refrigerant circulates between the gas cooling unit 20 and the gas heating unit 23; a refrigerant cooling unit 28 that is provided upstream of the gas cooling unit 20 and downstream of the gas heating unit 23 in the circulation direction of the circulation path 26 and lowers the temperature of the refrigerant; a refrigerant heating unit 27 that is provided downstream of the gas cooling unit 20 and upstream of the gas heating unit 23 in the circulation direction of the circulation path 26 and raises the temperature of the refrigerant; and a catalyst 25 that is provided downstream of the gas heating unit 23 in the flow path 10 and decomposes methane contained in the second gas.

Since the methane purification apparatus 1 is configured as described above, in the methane purification apparatus 1, the gas heating unit 23 can heat the second gas, which contains the first gas from which the water vapor has been removed by the gas cooling unit 20 and ozone supplied by the ozone supply unit 22. As a result, the methane purification apparatus 1 can cause methane and ozone contained in the second gas to react while suppressing the reaction sites on the catalyst 25 from being blocked by water, formed by condensation of water vapor contained in the second gas, adhering to the catalyst 25. Furthermore, in the methane purification apparatus 1, the gas heating unit 23 heats the second gas containing the first gas cooled by the gas cooling unit 20, so that methane can be decomposed at the temperature at which methane and ozone readily react.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

What is claimed is:

1. A methane purification apparatus comprising:
a flow path through which a first gas containing methane flows;
a gas cooling unit that cools the first gas by exchanging heat between the first gas flowing through the flow path and a refrigerant;
an ozone supply unit that supplies ozone to the first gas cooled by the gas cooling unit;
a gas heating unit that is provided downstream of the gas cooling unit in the flow path and heats a second gas by exchanging heat between (i) the second gas containing the first gas flowing through the flow path and the ozone supplied by the ozone supply unit and (ii) the refrigerant;
a circulation path that connects the gas cooling unit and the gas heating unit and in which the refrigerant circulates between the gas cooling unit and the gas heating unit;
a refrigerant cooling unit that is provided upstream of the gas cooling unit and downstream of the gas heating unit in a circulation direction of the circulation path and lowers a temperature of the refrigerant;
a refrigerant heating unit that is provided downstream of the gas cooling unit and upstream of the gas heating unit in the circulation direction of the circulation path and raises the temperature of the refrigerant; and
a catalyst that is provided downstream of the gas heating unit in the flow path and decomposes methane contained in the second gas.

2. The methane purification apparatus according to claim 1, further comprising:
a detection unit that detects a temperature of the catalyst; and
a temperature control unit that causes the refrigerant heating unit to heat the refrigerant so that the temperature detected by the detection unit falls within a temperature range, which indicates temperatures at which an amount of methane decomposed by the catalyst, of an amount of methane contained in the second gas, is equal to or greater than a predetermined ratio.

3. The methane purification apparatus according to claim 2, further comprising:
a storage unit that stores a methane decomposition rate map indicating a methane decomposition rate corresponding to the temperature of the catalyst, for each type of a coating layer of the catalyst, wherein the temperature control unit 423 identifies the temperature range by referencing the methane decomposition rate map.

4. The methane purification apparatus according to claim 3, further comprising:
a methane decomposition unit that houses the catalyst, wherein the temperature control unit acquires catalyst identification information for identifying the catalyst from the methane decomposition unit, and identifies the temperature range in the type of the catalyst corresponding to the catalyst identification information.

5. The methane purification apparatus according to claim 1, wherein the catalyst includes zeolite, iron ion-exchanged zeolite, or cobalt ion-exchanged zeolite.

6. The methane purification apparatus according to claim 1, further comprising:
a detection unit that detects a temperature and a humidity of the first gas at an inlet of the flow path; and
a temperature control unit that identifies a target temperature for removing water vapor contained in the first gas on the basis of the temperature and the humidity, and causes the refrigerant cooling unit to cool the refrigerant so that the temperature of the first gas reaches the target temperature.

7. The methane purification apparatus according to claim 1, further comprising:
a water tank that stores water generated by cooling the first gas in the gas cooling unit;
a warning lamp that indicates whether the water tank is full; and
a purification control unit that stops the gas cooling unit, the gas heating unit, the refrigerant cooling unit, and the refrigerant heating unit and turns on the warning lamp when an amount of water stored in the water tank is equal to or greater than a predetermined amount.

8. The methane purification apparatus according to claim 1, further comprising:
a detection unit that detects a temperature of the catalyst; and
a temperature control unit that causes the refrigerant heating unit to heat the refrigerant so that the temperature detected by the detection unit falls within a temperature range indicating temperatures at which an amount of methane decomposed by the catalyst, of an amount of methane contained in the second gas, is equal to or greater than a predetermined ratio, wherein the temperature control unit includes a feedback controller that sets a temperature within the temperature range as a target heating temperature, and adjusts a rotation speed of a motor of a compressor included in the refrigerant heating unit so as to reduce a temperature difference between a temperature of the second gas and the target heating temperature.

9. The methane purification apparatus according to claim 8, wherein the detection unit 421 may further detect a temperature and a humidity of the first gas at an inlet of the flow path 10, and
the temperature control unit adjusts a valve opening degree of an expansion valve included in the refrigerant cooling unit so as to reduce a temperature difference between the temperature of the first gas detected by the detection unit and the target cooling temperature corresponding to the humidity and the temperature of the first gas detected by the detection unit.

10. The methane purification apparatus according to claim 9, wherein the temperature control unit lowers the target heating temperature of the refrigerant heated by the refrigerant heating unit, as the target cooling temperature of the refrigerant cooled by the refrigerant cooling unit becomes lower.

11. The methane purification apparatus according to claim 9, wherein the larger the valve opening degree of the expansion valve included in the refrigerant cooling unit is, the lower the temperature control unit sets a target heating temperature within the temperature range, and the more the temperature control unit reduces the rotation speed of the motor of the compressor included in the refrigerant heating unit.
